(19) United States
(12) Patent Application Publication
(10) Pub. No.: US 2022/0049055 A1
(43) Pub. Date: Feb. 17, 2022

(54) CONTINUOUS SOLID-STATE POLYMERIZATION PROCESS AND REACTOR COLUMN FOR USE THEREIN

(71) Applicant: DSM IP Assets B.V., Heerlen (NL)

(72) Inventor: Eric GROLMAN, Echt (NL)

(21) Appl. No.: 17/414,017

(22) PCT Filed: Dec. 18, 2019
(86) PCT No.: PCT/EP2019/085850

§ 371 Date: Jun. 15, 2021

(30) Foreign Application Priority Data
Dec. 21, 2018 (EP) 18215057.3

(51) Int. Cl. C08G 69/30; B01J 19/24; B01J 19/00; B01J 4/00

(52) U.S. Cl. CPC C08G 69/30; B01J 19/242; B01J 19/0013; B01J 2219/00081; C08G 2250/00; B01J 2204/005; B01J 4/001

(57) ABSTRACT

The invention relates to a continuous solid-state polymerization process for preparing a polyamide derived from diamine and dicarboxylic acid, wherein the salt is polymerized in a reactor column comprising successive multifunctional zones comprising heating sections and gas-outlet sections, wherein the heating sections comprise static heat exchangers. The invention also relates to the reactor column and use thereof in a continuous solid-state polymerization process.

The present invention relates to a process for preparing a polyamide, more particular to a continuous solid-state polymerization process for preparing a polyamide derived from diamine and dicarboxylic acid.

The preparation of polyamides from diamines and dicarboxylic acids involves the reaction between the amine groups in the diamines and the carboxylic acid groups in the dicarboxylic acids, resulting in amide groups with the formation of water as side product. This reaction is a condensation reaction, and the process is known as a polymerization process involving polycondensation. Polyamides derived from diamines and dicarboxylic acids are also known as AA-BB polyamides.

There are various ways to produce a polyamide from diamines and dicarboxylic acids. The known processes include melt polymerization, solution polymerization, suspension polymerization, and solid-state polymerization, and combinations thereof. Polyamides prepared from diamine and dicarboxylic acid are often manufactured by condensing appropriate salts of diamine and dicarboxylic acid in a molten state, or in a liquid state where the salt is dissolved in water. Such a procedure wherein the salt is polymerized in the molten state or dissolved in water, however, is less suitable for more heat-sensitive and high melting polyamides, as this generally leads to side reactions resulting in degradation of the polymers or branching and gel formation. Therefore, there is an interest in low temperature processes for their preparation. Well-known and widely applied processes for the preparation of polyamides are multi-step processes comprising solid-state post condensation as a further or final step. Examples thereof include processes wherein in a first step a prepolymer is made in aqueous solution, in suspension in an inert liquid, or in a melt. The prepolymer so formed is isolated from the solution or suspension, and solidified, or directly solidified from the melt, and further polymerized to a higher molecular weight polymer while in solid-state. Such process step comprising further polymerization of a prepolymer in the solid-state is also known as a solid-state post-condensation (or SSPC) process, which is referred to herein as Post-SSP.

For AA-BB polyamides also solid-state polymerization processes are known wherein salts of diamine and dicarboxylic acid are polymerized directly to a polyamide polymer of desired molecular weight, with all steps in the solid state, starting, for example, with a salt in the form of a powder. Such a full solid-state polymerization is also known as direct solid-state polymerization, which is referred to herein as Direct-SSP.

Solid-state polymerization processes for polyamides, both Post-SSP and Direct-SSP are described in the book “Solid-state Polymerization” by. C. D. Papaspyrides and S. N. Vouyiouka, Wiley, 2009.

Although solid-state polymerization processes for polyamides have been known for a long time, and Post-SSP processes are applied globally extensively on industrial scale, Direct-SSP processes have remained primarily subject of technical and scientific studies, and are hardly applied, if at all, on industrial scale. This even though Direct-SSP is energetically very attractive, since only the salt is heated, and only to a temperature below the melting point of the salt and the polyamide. This is in contrast with processes comprising a melt step followed by Post-SSP, wherein the salt is first heated to a temperature above the melting point of the salt and the polyamide prepolymer, after which the prepolymer is cooled and converted into granules, and in contrast with processes involving polymerization in an aqueous solution or in a suspension, followed by Post-SSP, wherein the salt is first dissolved or suspended in water or in an inert liquid, the solution or suspension is heated to a temperature and pressure high enough to prepare polyamide prepolymer, after which the water or the inert liquid has to be removed and the prepolymer is isolated and cooled and converted into granules, and after which the granules are heated again to further polymerize the prepolymer in the Post-SSP step to obtain the polyamide.

A huge problem in upscaling Direct-SSP to industrial scale is the amount of condensation water that is produced during the polymerization. This amount can be well in the range of 10 to 15 wt. %, relative to the weight of the starting materials of diamine and dicarboxylic acid. This condensation water must be removed from the reaction mixture or reaction medium. In processes wherein a prepolymer is made in aqueous solution, in suspension in an inert liquid, or in a melt, followed by a solid-state post-condensation step, the largest part of the condensation water is already produced and removed in the first step, wherein the reaction mixture is still in a mobile liquid state. In a Direct-SSP process, this can be accomplished in a batch process with a stirred bed of granular material or, on very small scale, with a static packed bed of granular material. In both situations, either with a stirred bed, or with a very small scale static bed batch process, the reaction speed must be very slow and carefully controlled to prevent the produced condensation water and the initially formed low molecular weight prepolymer from causing sticking and agglomeration of the granular material. These problems of sticking and agglomeration are described in, for example, “Solid-state Polymerization” by. C. D. Papaspyrides and S. N. Vouyiouka, Wiley, 2009. These aspects make upscaling to industrial scale difficult and make the process economically inefficient, since reaction times are long, reducing reactor capacity and making equipment costly.

Solid state polymerization apparatus and assemblies, as well as suitability and drawbacks thereof, are also described in Solid-state Polymerization” by. C. D. Papaspyrides and S. N. Vouyiouka, Wiley, 2009 (page 26-28). To prevent such problems of sticking or sintering, solid-state polymerization is either carried out under stirring or other forms of mechanical agitation. These processes can be carried out under a stream of nitrogen gas. Suitably, a combination of stirring and a stream of nitrogen gas is applied.

During the whole process the reaction mixture is stirred, in order to keep the particles moving with respect to each other. Such a process can be carried out as a batch process, for example in a stationary apparatus in which reaction proceeds while stirring with a rotary vane mounted on a top side of a vertical reactor, or in a tumbler type apparatus in which starting material is introduced into a reactor, both upper and lower portions of which are conical, and the reactor is sealed, followed by performing reaction while rotating the entire body of the reactor under a vacuum.

Such equipment can be used in a batch process, however, has disadvantages of low output per batch cycle, long cycle time, and huge energy loss due to continuous repetition of heating and cooling processes for reaction, all of which lead to increase in production costs. Scaling up of such equipment for large scale production, using equipment with moving parts, sealing parts and heating elements, is all very costly.

On the other hand, continuous processes are often applied in post-condensation for increasing the molecular weight and intrinsic viscosity of prepolymers. Herein solid polyamide prepolymer is fed through a reactor without stirring, moving downwardly as a packed bed of granulate material, meanwhile applying a countercurrent of heated inert gas for heating the granulate polyamide material and removing the water vapor resulting from the solid-state post-condensation reactions. Maintaining a packed bed with a plug flow character is essential for obtaining a product with a consistent and desired end-viscosity within a reasonable residence time.

In a Direct-SSP process, the amount of water produced is typically much higher than in post-condensation processes, it can be about ten times as high, or even more. When the water vapor resulting from the condensation reactions is not continuously and effectively removed from the reactor, without stirring, the solid granulate material will cake and form big lumps. Preventing this would require such a large gas flow, that it could even result in fluidizing and entrainment of the salt particles from the top of the reactor, and otherwise would require very wide equipment to reduce the gas velocity leading to very long residence times. Furthermore, this would also require extensive investment in equipment and extensive costs for cleaning, drying, reheating and recycling of the stream of inert gas. Altogether this would make such a process very uneconomical.

In view of the above there is a need for an economic process, in terms of energy costs and scalability, while limiting the risk of sticking and agglomeration in a Direct-SSP.

Therefore, the goal of the present invention is to provide a solid-state polymerization process for preparing a polyamide that is economically attractive and scalable to large industrial scale and in which the risk for sticking and agglomeration is reduced to the minimum.

This goal has been achieved with the process according to the invention, which is a continuous solid-state polymerization process for preparing a polyamide derived from diamine and dicarboxylic acid, which process is carried out in a flow-through reactor comprising a reactor column comprising successive zones with different sections. The process according to the invention comprises steps of:
feeding solid diammoniumdicarboxylate salt into a reactor column comprising successive multifunctional zones comprising heating sections and gas-outlet sections;
transporting the salt, or where applicable a polymerizing mixture or a polyamide resulting thereof, as a moving packed bed through the successive multifunctional zones, while
   heating the salt, respectively the polymerizing mixture and polyamide in the heating sections, thereby polycondensing the salt to form a polymerizing mixture, respectively further polycondensing the polymerizing mixture to form a polyamide, and optionally further polycondensing the polyamide to form a polyamide with higher molecular weight, and producing water vapor, and
   removing the water vapor via gas-outlet sections; and
discharging the resulting polyamide from the reactor column;
wherein the salt, the polymerizing mixture and polyamide are kept in the solid-state and
wherein the heating sections comprise static heat exchangers.

In the process according to the current invention, solid material is transported substantially by gravity and is moving as a moving packed bed through the reactor column. The solid material is heated by means of static heating elements in the heating sections. By using a reactor column comprising successive multifunctional zones comprising heating sections and gas-outlet sections, the solid material that is used in the process, is transported through a sequence of heating sections alternated with gas-outlet sections. Thus, the water vapor produced in a heating section is primarily removed via a gas-outlet section, or via gas-outlet sections adjacent to or nearby said heating section. With an adjacent or nearby gas-outlet section or a nearby array of gas outlet devices next to a heating section is herein meant a gas-outlet section, respectively an array of gas outlet devices directly upstream or directly downstream of the said heating section, and thus positioned between the said heating section and the first next upstream or downstream heating section.

Effectively, in the process according to the current invention, the water resulting from the condensation reactions between amine and acid groups is removed as superheated steam, without the need of inert gas as a carrier gas, via outlets in upward and downward direction and split in multiple zones, with limited hydrodynamic upward forces in the multifunctional zones, and a zero or almost zero net hydrodynamic force in the packed bed, while having drastically limited the risk of sticking and agglomeration without using stirring, thus promoting a steady downward flow of the moving packed bed, and meanwhile also having an overall very good temperature control throughout the reactor and having drastically limited the risk of or even eliminated fluidization and entrainment of particles from the reactor.

The term adjacent is also used herein in respect of multifunctional zones and is meant herein to refer to multifunctional zones positioned in an upstream or downstream order directly next to each other.

With solid state in the expressions “solid-state polymerization”, “solid diammoniumdicarboxylate salt” and “keeping the salt, the polymerization mixture and the polyamide in the solid state” is herein meant that the key components, being the starting material, i.e. the salt, and the main reaction products, i.e. oligomers and other constituents in the polymerization mixture, and the polyamide, retain a solid state. This does not exclude that volatile components can be formed and released from or absorbed by the solid material, without changing the solid nature of the key components that make up the majority of the mass. Because of the retention of the solid state, the salt can be fed as a particulate material, for example a powder or a granular material, and the salt, the polymerizing mixture and the polyamide can be transported by gravity, or at least substantially so, downward through the reactor column as a solid particulate material with retention of their particulate form.

The advantages of the process according to the invention are first of all that it is a continuous process, with all operational advantages over batch processes, enabling the integration of all steps of salt handling, (pre-)polymer preparation and post-condensation in one integral sequence, without the need of dissolving and melting steps and intermediate isolation or cooling steps, and further that the process is low in energy costs for heating, does not require extensive expensive stirring equipment, is scalable to large industrial scale and has a low risk of sticking and agglomeration despite the large amount of condensation water produced in the polycondensation steps. More particular, through the segmentation of the heating segments where the condensation reactions predominantly take place, effective removal of the condensation water from the heating segments is achieved with a relatively low amount of inert gas, if at all, while at the same time the risk of wetting by condensation of water on cold material, being either the salt starting material or polyamide product in other segments after cooling, thereby causing sticking and agglomeration, is minimized.

The advantages of the process according to the invention are further that water vapor is removed without the need of large volumes of inert gas for entrainment of the water vapor or expensive reactors or equipment for stirring the salt and polymerizing mixture to transfer the heat from the wall to the reacting mass, and the process is economically friendly in that energy needed for heating the salt and energy loss through streams of inert gas are minimized, and that the process can be scaled to large production size. Furthermore, the process according to the invention allows for efficient heat transfer with small temperature gradients, and low static pressure, thereby minimizing chances of sticking and agglomeration.

By applying multiple multifunctional zones in the reactor column, each comprising a heating section and a gas-outlet section, thereby dividing the reactor column in successive sections comprising heating sections alternated with gas-outlet sections, the amount of water vapor produced per heating section is kept limited and is simply expelled from the heating sections and removed via nearby gas-outlet sections by the overpressure resulting from the production of water vapor by the polycondensation reaction, without the need of a stream of inert gas to entrain and remove water vapor, while simultaneously preventing sticking and agglomeration, thus allowing the use of a large and easily moving packed bed in the Direct-SSP process, wherein the salt, the polymerizing mixture and polyamide are kept in the solid-state.

Additional advantages are that the process according to the invention can be carried out at conditions of atmospheric pressure or close to atmospheric pressure, as the water vapor can escape even when being at essentially atmospheric pressure; without use of a carrier gas, while with the upward and downward in-situ removal of the water vapor, the gas velocities in the present invention are further reduced, thereby allowing for a large range of particle sizes, thus no need not limit the use of the apparatus to particles of large size, which would otherwise severely limit available techniques for making the salt precursor particles. In conventional Post-SSP processes, involving gas-heated columns, with typical cases requiring large residence times (often ≥24 hours), temperature upsets can last a long time and be the cause of a lot of off-spec material. The process according to the invention, using several contact-heating sections in combination with multiple gas-outlet sections in one flow-through column, allows for a much better steering and control of the (local) temperature inside the reactor column, enabling much less off-spec product being produced during start-up, grade changes and upset situations.

In the process according to the invention, water vapor produced via the condensation reactions in a multifunctional zone is at least partly removed via the gas-outlet section in the multifunctional zone and optionally via a nearby gas-outlet section in an adjacent multifunctional zone. The process can be carried out without any need for inert gas fed into the multifunctional zones, and otherwise, if inert gas is added at all, the amount of inert gas can be kept very low. Suitably, the reactor column does not comprise gas inlets in or between any of the heating sections in the multifunctional zones.

The polycondensation in the process according to the invention is suitably carried out in an inert atmosphere. This may be accomplished by applying a purge of an inert gas into the reactor column at the start-up of the process, and a small flow of inert gas fed into the reactor column at suitable locations, such as near the inlet position of salt and near the discharge position of the polymer.

As inert gas any gas inert for polyamides can be used. Examples of such gases are nitrogen, carbon dioxide and argon. Preferably, nitrogen is used as inert gas. It is noted that the water vapor formed by the condensation reactions also helps in inertizing the reactor content.

The process according to the invention can be carried out while feeding an inert gas into the multifunctional zones or without feeding an inert gas into the multifunctional zones. Suitably, the mass flow rate of inert gas fed into the multifunctional zones, if any, is at most 50%, on a mass basis, relative to the mass flow rate of the solid diammoniumdicarboxylate salt fed into the reactor column. With the expression if any is meant that it is possible that the amount can be zero, i.e. that no inert gas is fed into the multifunctional zones. Preferably, the mass flow rate of inert gas fed into the multifunctional zones is at most 40%, more preferably at most 25%, even more preferably at most 10% of the mass flow rate of the solid diammoniumdicarboxylate salt fed into the reactor column. The advantage of a low or zero mass flow rate of inert gas is that the cost of nitrogen, cost of construction and loss of volatile monomers are all reduced, hence the processing costs are lower and carriage of water vapor resulting from the condensation reactions to other zones, where it could condense, is reduced. Another advantage is that the even flow (i.e. plug flow) of solids through the reactor is least disturbed by minimizing the flow of gas, hence lowering the mass flow rate of inert gas.

Ultimately, using no inert gas has the advantage that the risk of fluidizing the powder particles in the packed powder bed and entrainment of powder particles into the gas-outlets is further reduced, and that by raising the energy input in said heating section or heating sections, the polycondensation reactions can be enhanced, while water vapor produced by said reaction in a heating section can still escape from the reactor column via the two nearby gas-outlet sections, without enhancing said risk of fluidization.

In the process according to the invention, the solid diammoniumdicarboxylate salt is suitably fed into the reactor column via a charging section and the resulting polyamide is discharged from the reactor column via a discharge section, while an inert gas is fed into the charging section or into a section nearby the charging section, or into the discharge section or into a section nearby the discharge section, or into both. This has the advantage that respectively the charging section and the discharging section are purged or blanketed with an inert gas, thus preventing oxygen entering the reactor column and eliminating the need for a purge of inert gas in or through the heating sections, where the polycondensation reactions take place, to prevent oxygen entering the heating sections. For blanketing the charging section with inert gas, it may be sufficient, for example, to apply a purge of inert gas on a supply unit from which the solid diammoniumdicarboxylate salt is charged into the charging section of the reactor column.

The amount of inert gas fed into the charging section, the section nearby the charging section, the discharge section and the section nearby the discharge section, where applicable, can be kept low, while still being sufficient to blanket the charging section and the discharge section while preventing oxygen entering the reactor column and preventing volatile components (water, diamines) from leaving the reactor column via the charging and discharging sections.

The process according to the invention can be carried out at a pressure, or pressures, varying over a wide range from well below atmospheric pressure to far above. Suitably the process is carried out at atmospheric pressure (0 BarG, typically about 1 bara) or slightly below or above. The process may be carried out at a pressure below atmospheric pressure, but in that case preferably measures are taken to avoid air entering the reactor column and to make water vapor escape from the reactor column. The process may also be carried out at a pressure well above atmospheric pressure. This has the advantage that the risk for air entering the reactor column is reduced. Of course, designing for overpressure puts higher demands on the construction of the reactor. Preferably, the process is carried out at a gas pressure in the range of 0.9-1.5 bara, more preferably 0.95-1.2 bara, and even more preferably 1.0-1.1 bara. Herein the pressure is expressed in bars in absolute numbers. Alternatively, the process is preferably carried out at a gas pressure in the range of −0.1 to +0.5 BarG, more preferably −0.05 to +0.2 BarG, and even more preferably 0 BarG to 0.1 BarG. Herein the pressure is expressed in bars relative to atmospheric pressure. Herein the pressure is the pressure as measured at the exits of the gas-outlet sections in the multifunctional zones.

The process according to the invention suitably comprises a step, wherein the salt is pre-heated or dried, or a combination thereof, prior to entering a multifunctional zone wherein the salt is further heated and polycondensed. Such a pre-heating and drying step may be desirable when the salt comprises some volatiles, such as free water or crystal water. It is noted that during those phases of the process wherein the condensation reactions take place, a large amount of water results from the condensation reactions. This amount can be as high as 10-15 wt. %, for example 12 wt. % or 13 wt. %, relative to the weight of the salt, and even be lower or higher, depending on the molecular weight of the monomers. Next to that, the starting material comprising the salt may contain some water, being crystallized with, or absorbed by or adhered to the salt, without affecting the salt retaining its solid granular shape. Such crystallized, absorbed or adhered water can be, for example, 1.0 or 1.5 wt. % and may well amount to about 0-2.5 wt. % relative to the weight of the salt, and even higher. Such water is suitably removed, for example, by heating the salt to a temperature above 100° C., or by applying vacuum, or a combination thereof. Drying may be done inside the reactor column or outside the reactor column by heating the salt, or outside the reactor column by other means.

Suitably, the process comprises a combined pre-heating-and-drying step prior to the salt being fed into and entering the reactor column. Preferably, the pre-heating-and-drying is done inside the reactor column. This has the advantage that the heating and drying step can be integrated with the further heating steps in the reactor column, thereby simplifying the process design, which becomes less complicated, thus decomplexing the required installations so that less auxiliary equipment is needed, and investment costs are reduced. Herein, the process may comprise a separate salt pre-heating-and-drying step, or a step wherein the pre-heating and drying are combined with the first part of the polycondensation of the salt.

In a particular embodiment, the process comprises a pre-heating-and-drying step, comprising
transporting the salt from a charging section to and through a first multifunctional zone comprising a heating section and an adjacent gas-outlet section, while
   heating the salt in the heating section, thereby optionally at least partly evaporating water from the salt, if any present, and drying the salt, to form a pre-heated salt and optionally produce water vapor, while keeping the salt in the solid state; and
   releasing water vapor, if any, through the adjacent gas-outlet section; and
transporting the pre-heated salt from the first multifunctional zone to further multifunctional zones.

The heat exchanger in the first multifunctional zone is heated to a temperature referred to as T1.

In this pre-heating and drying step, the heat exchanger in the first multifunctional zone is suitably heated to a temperature T1 in the range of 100-220 ° C., preferably 110-210 ° C., more preferably 120-200 ° C. Also suitably, T1 is kept below Tₒₙₛₑₜ, preferably below {Tₒₙₛₑₜ−5° C.}, more particular more than 10° C. below Tₒₙₛₑₜ. The advantage of a lower heating temperature T1 is that during the heating step the salt can be heated faster and dried while water vapor produced from initial condensation reactions, if any, is limited.

With the term onset temperature Tₒₙₛₑₜ is herein understood the temperature, measured by TGA under nitrogen with the method according to ISO-11358 with a first heating rate of 15° C./minute during a first heating step from 30° C. to 150° C., retention at 150° C. for 15 minutes, followed by a second heating rate of 10° C./minute during a second heating step from 150° C. to 250° C., and retention at 250° C. for 360 minutes, wherein T-onset is determined by the intersection of the starting-mass line and the tangent to the TG curve at the point of maximum gradient.

In another embodiment of the process according to the invention, pre-heating-and-drying may also be combined with a first part of condensation of the salt. Suitably, the process comprises herein a first heating step, wherein pre-heating-and-drying is combined with a first part of condensation of the salt, comprising
transporting the salt from a charging section to and through a first multifunctional zone comprising a heating section and an adjacent gas-outlet section, while
   heating the salt in the heating section, thereby at least partly evaporating water from the salt, if any present, and condensing at least a first part of the salt, to form a first polymerizing mixture and produce water vapor, while keeping the salt and the first polymerizing mixture in the solid state; and
   releasing water vapor through the adjacent gas-outlet section;
transporting the first polymerizing mixture from the first multifunctional zone to further multifunctional zones.

In this combined pre-heating, drying and condensation step, the heat exchanger is suitably heated to a temperature T1 above 210° C., preferably in the range of 220-260° C., more preferably 220-240° C. Herein T1 is also suitably at least equal to Tₒₙₛₑₜ, preferably at least equal to {Tₒₙₛₑₜ+5° C.}, more particular T1 is more than 10° C. above Tₒₙₛₑₜ. The advantage of a higher heating temperature T1 is that during the heating step the salt can be dried while simultaneously initial condensation reactions may take place.

This embodiment is suitably combined with an inert gas being fed into the charging section or into a section nearby the charging section. The advantage thereof is that the inert gas, or at least a part thereof, may flow through the heating section of the first multifunctional zone, entrain evaporated water and be released via the gas-outlet section, thereby reducing the risk of condensation of water vapor on cold solid material and excessive wetting of said cold solid material.

To keep the solid material in the column in the solid state, the salt, the polymerizing mixture and the polymer are suitably not heated to a temperature equal to or above the melting point of respectively the salt, the polymerizing mixture and the polymer. To keep the temperature of the salt, respectively of the polymerizing mixture and of the polymer, below its melting point, the static heat exchangers in the multifunctional zones are suitably heated to a temperature (referred to as Temperature Heat Exchangers, or ‘ T_{HE}’) sufficiently high such that reaction can take place, but still below the melting temperature of the salt (Tm-salt), respectively the meting temperature of the polymerizing mixture (Tm-mixture), and the melting temperature of the polyamide (Tm-polyamide). Preferably, T_{HE} of the static heat exchanger in a first multifunctional zone and optionally in one immediately following or more immediately following successive multifunctional zones is kept at least 15° C., more preferably at least 25° C. below the melting temperature of the salt (Tm-salt). Also, T_{HE} of the static heat exchanger in a last multifunctional zone and optionally in one or more immediately preceding multifunctional zones is preferably kept at least 15° C., more preferably at least 25° C. below the melting temperature of the polyamide (Tm-polyamide). More preferably, T_{HE} of the of the static heat exchangers in all multifunctional zones is kept at least 15° C., even more preferably at least 20° C., and most preferably at least 25° C. below the lowest of the melting temperature of the salt (Tm-salt), the meting temperature of the polymerizing mixture (Tm-mixture), and the melting temperature of the polyamide (Tm-polyamide). Herein the melting temperature (Tm) is the peak temperature measured by the DSC method according to ISO-11357-3.2, 2009, in a nitrogen atmosphere with heating rate of 20° C./min, in the first heating cycle.

The space in the reactor column in which the process is carried out is confined by the wall of the reactor column. In the process solid material is transported through the column, passing through multiple successive heating sections and gas-outlet sections. Herein, each of the sections is confined by a section of the wall of the reactor column. Suitably, the wall sections confining the multiple successive heating sections and gas-outlet sections are heated. The temperature of a wall section is herein also referred to as T_{WS}. In a particular embodiment of the process according to the invention, wherein the sections in the column are confined by wall sections of the column, the wall sections of the heating sections are heated to a temperature T_{WS} in the range from {T_{HE}−10° C.} to and including {T_{HE}+10° C.}. Preferably, T_{WS} is in the range from {T_{HE}−5° C.} to and including {T_{HE}+5° C.}.

The process according to the invention is carried out in a reactor column comprising multifunctional zones comprising heating sections and gas-outlet sections. Herein the number of such multifunctional zones may vary largely and may be for example as low as three (3), and as high as ten (10), and even higher. Suitably, the reactor column comprises at least 3 successive multifunctional zones comprising heating sections and gas-outlet sections. This can be sufficient in case when pre-heating-and-drying and a first part of the condensation are done in a first step in the first multifunctional zone, and the further polycondensation is done in the two successive multifunctional zones. The necessary heat input capacity in each of the heating sections can herein be attained by using sufficient contact surface, and where necessary by increasing the contact surface, particularly by increasing the length of the static heat exchangers, or by reducing the distance between the plate heat exchangers or the diameter of the tubes in the case of shell-and-tube heat exchangers.

Preferably, the reactor column comprises at least 4 successive multifunctional zones. This can be sufficient in case when pre-heating-and-drying is done in a first step in the first multifunctional zone, and the polycondensation is done in the three successive multifunctional zones. The advantage hereof is that the capacity for water vapor removal is increased thereby increasing the through-put capacity of the reactor column

More preferably, the reactor column comprises at least 5 successive multifunctional zones, still more preferably at least 6, and even better at least 7 successive multifunctional zones. The advantage thereof is that the polycondensation can be done in and split over more successive multifunctional zones, thereby allowing a higher through-put through the column without increasing the risk of sticking and agglomeration of the solid material in the moving packed bed and distributing the water vapor formed over more gas removal sections, thus reducing the risk of entraining solid material into the gas removal sections.

Once the polyamide is produced, the polyamide is suitably cooled prior before being collected or packed or further processed. This cooling may be done outside the reactor column after discharging the polyamide from the reactor column, or alternatively inside the reactor column before discharging the polyamide from the reactor column. In a preferred embodiment, the polyamide is cooled inside the reactor column. For that purpose, the reactor column suitably comprises a cooling zone comprising at least one cooling section comprising static heat exchangers and the process comprises a cooling step, prior to the discharging step, comprising transporting the polyamide to and through the cooling section, while cooling the polyamide in the cooling section, and transporting the cooled polyamide to a discharge section. The advantage of this embodiment is that the process allows multiple process steps to be combined in one, transporting the solid material through the reactor column, without need for additional expensive or complex, air-tight equipment.

The cooling step may optionally be combined with a drying step. Suitably, herein a drying gas is fed into the cooling zone in one or more gas-inlet sections and the drying gas is removed via one or more gas-outlet sections. Since the process is highly efficient in letting off water vapor, the amount of drying gas needed in the cooling step can be kept rather limited, thereby saving costs. Suitably, the mass flow of drying gas fed into the cooling zone is equal or less than, more particular less than half of the mass flow of diammonium dicarboxylate salt fed into the reactor column.

For that purpose, the reactor column suitably comprises a cooling zone comprising a first cooling section comprising static heat exchangers, a gas-inlet section, and a second cooling section comprising heat exchangers, and the process comprises a cooling step, prior to the discharging step, comprising, in this order,
a. transporting the polyamide to and through the first cooling section, while cooling the polyamide in the first cooling section;
b. transporting the polyamide to and through the gas-inlet section;
c. transporting the polyamide to and through the second cooling section, while further cooling the polyamide in the second cooling section;
d. and transporting the cooled polyamide to the discharge section;
while feeding a drying gas into the reactor column via one or more gas-inlet section(s) and removing drying gas via one or more upstream and/or downstream gas-outlet section(s).

The solid diammoniumdicarboxylate salt used in the process according to the invention and fed into the reactor column can be a particulate material having particle sizes and particle size distributions varying over a wide range. The salt can be for example, a powder, more particular a powder with a small particle size, or a granular material, more particular a granular material with medium or larger size of granules. Suitably, the solid diammoniumdicarboxylate salt has a particle size distribution with a median particle size (d50), measured with laser granulometry by the method according to ISO 13320-1 at 20° C., in the range of 0.05-10 mm, preferably 0.1-5 mm, more preferably 0.2-3 mm. The advantages of a median particle size of at least 0.2 mm or higher are that the flow properties are better, bulk density of the powder is higher and that the powder has limited tendency to get entrained into the gas outlets. The advantage of a median particle size of at most 3 mm is in addition to the above, that the particles are still small enough to pass through relatively narrow heat exchanger passages inside the column in an even and undisturbed manner, and that they can easily be processed on an extruder afterwards.

For a granular material with a median particle size (d50), below 1 mm, the particle size distribution and median particle size are suitably measured with laser granulometry by the method according to ISO 13320-1 at 20° C. For a granular material with a median particle size (d50) of 1 mm or above, the particle size distribution and median particle size are suitably measured with the sieve method according to DIN 66165 (2016) Part 1&2.

The solid diammoniumdicarboxylate salt used in the process according to the invention can in principle be any diammoniumdicarboxylate salt that can be polymerized by direct solid-state polymerization. The process according to the invention can be applied for a wide range of polyamides, including aliphatic polyamides, semi-aromatic polyamides and fully aromatic polyamides. Herein, semi-aromatic polyamides and fully aromatic polyamides, more particularly the semi-aromatic polyamides are preferred. For aliphatic polyamides, the salt can be based on fully aliphatic components, i.e. aliphatic diamines and aliphatic dicarboxylic acids. Salts based on fully aromatic components, i.e. aromatic diamines and aromatic dicarboxylic acids, result in fully aromatic polyamides. Most preferably, the salt, as well as semi-aromatic polyamides derived thereof, are based on diamines and dicarboxylic acids comprising both aliphatic and aromatic monomers. For such semi-aromatic polyamides, the combination of aromatic components and aliphatic components may comprise, for example, aliphatic diamine and aromatic dicarboxylic acid, or aromatic diamine and aliphatic dicarboxylic acid, or any combination thereof. The polyamide prepared by the process suitably is a semi-crystalline polyamide. Such a polyamide comprises an amorphous phase and a crystalline phase next to each other.

In a particular embodiment of the process according to the invention, the polyamide produced in the process is a semi-aromatic polyamide, and the diammoniumdicarboxylate salt used in the process is a salt of a diamine comprising an aliphatic diamine and a dicarboxylic acid comprising an aromatic dicarboxylic acid. In a preferred embodiment thereof, the solid diammoniumdicarboxylate salt comprises an aliphatic diamine and an aromatic dicarboxylic acid, and the polyamide herein prepared is a semi-crystalline semi-aromatic polyamide having a melting temperature of at least 280° C., preferably at least 290° C. Herein, the melting temperature is measured by the DSC method according to ISO-11357-3.2, 2009, in a nitrogen atmosphere with heating rate of 20° C./min, in the first heating cycle.

Suitably, the diammoniumdicarboxylate salt used in the process to prepare such semi-crystalline semi-aromatic polyamide is a salt of a diamine comprising at least 70 mole % of a linear aliphatic diamine with 4-12 carbon atoms, and a dicarboxylic acid comprising at least 70 mole % of an aromatic dicarboxylic acid selected from terephthalic acid, naphthalene dicarboxylic acid and 4,4′-biphenyl dicarboxylic acid. The process is in particular advantageous for these polyamides as these are more difficult to produce in a melt process.

In the embodiment wherein the polyamide prepared by the process according to the invention is a semi-crystalline semi-aromatic polyamide having a melting temperature of at least 290° C., the salt is suitably heated to a temperature of at most 230° C., preferably at most 220 in a first multifunctional zone, and to a temperature in the range of Tₒₙₛₑₜ−265° C. in further multifunctional zones.

The polyamide produced in the process according to the invention may have a degree of polymerization varying over a wide range, as well as in connection with the degree of polymerization, have a viscosity varying over a wide range. Suitably, the polyamide discharged from the reactor column has a viscosity number of at least 20 ml/g, preferably at least 50 ml/g, measured in 96% sulphuric acid (0.005 g/ml) at 25° C. by the method according to ISO 307, fourth edition. Also suitably the polyamide has a conversion of carboxylic acid groups into amide groups of at least 90%, preferably at least 95%, more preferably at least 98%, relative to the carboxylic acid groups in the solid diammoniumdicarboxylate salt. Herein the concentration of acid groups in the polyamide is determined by titration and expressed in mmol/kg polyamide, and the concentration of acid groups in the salt is calculated from the molecular weights of the diamine and the carboxylic acid in the salt and expressed in mmol/kg salt.

The current invention also relates to a reactor column, more particular to a reactor column for a continuous solid-state polycondensation process as described herein above. The process according to the invention is also suitably carried out in a reactor column as described herein below.

The reactor column according to the invention comprises at least three successive multifunctional zones each comprising a heating section comprising static heat exchangers and a gas-outlet section. The reactor column is suitable for use in a continuous solid-state polycondensation process, such as for preparing a polyamide from a diammoniumdicarboxylate salt. By dividing the reactor column in multifunctional zones, each comprising a heating section and a gas-outlet section, thus alternating heating sections with gas-outlet sections, the amount of water vapor produced in a continuous solid-state polycondensation process in each heating section can be kept limited and the water vapor can simply be expelled from the heating sections and removed via nearby gas-outlet sections by overpressure resulting from the water vapor formed by the condensation reactions, without the need for a stream of inert gas to entrain and remove water vapor, while local high temperatures and moderate pressures effectively prevent sticking and agglomeration. This enables employing a moving packed bed of solid state material moving through the column while the salt gets converted into polymer.

Suitably, the at least three successive multifunctional zones in the reactor column do not comprise a gas inlet. Thus neither in a heating section or in a gas-outlet section, nor between any of the heating sections, nor between a heating section and a gas-outlet section in the multifunctional zones.

As mentioned above, at least 3 successive multifunctional zones can be sufficient in case when pre-heating-and-drying are combined with some first condensation in the first multifunctional zone, and the further polycondensation is accomplished in the two successive multifunctional zones.

In a preferred embodiment, the reactor column comprises at least 4 successive multifunctional zones comprising heating sections and gas-outlet sections, more preferably at least 5, still more preferably at least 6 and even more preferably at least 7 of the multifunctional zones.

As mentioned herein above, the advantage of more successive multifunctional zones is that the polycondensation of a solid starting material for preparing a polymer, for example for preparing a polyamide from a diammoniumdicarboxylate salt, can be done in the reactor column in and split over more successive multifunctional zones, thereby allowing a higher through-put through the column without increasing the risk of sticking and agglomeration of solid material or increasing the risk of entrainment of solid material comprising the starting material or the polymer, such as the salt and the polyamide, in a moving packed bed in the reactor column.

In a preferred embodiment of the reactor column according to the invention, the static heat exchangers are selected from vertically or essentially vertically oriented tubular heat exchangers and vertically or essentially vertically oriented plate heat exchangers. The reactor column with such static heat exchangers is advantageously used in the process according to the invention, as it allows for highly efficient heat transfer and in addition allows a moving packed bed of solid material to be transported through the reactor column by gravitational forces while minimizing hindrance for such transport. A further advantage is that such tubular heat exchangers and plate heat exchangers can be regularly spaced from one another and distributed uniformly over a cross section of the heating sections and, where applicable, one or more cooling sections.

In a particular embodiment thereof, the tubular heat exchangers have an inner diameter in the range of 0.5-5 cm and a core-to-core distance in the range of 1-8 cm. Herein the solid material is flowing through the tubes, while the solid material can be heated via the tubes by hot oil flowing in an interstitial space surrounding the tubes.

In another particular embodiment, the plate heat exchangers have
a thickness in the range of 0.2-3 cm, preferably 0.3-2.5 mm, more preferably 0.5-2 cm; and/or
a core-to-core distance in the range of 1-12 cm, preferably 2-8 cm; and/or
a plate-to-plate distance between the plates in the range of 0.5 mm-8 cm, preferably 1-6 cm, more preferably 2-5 cm.

Plate heat exchangers with a smaller thickness have the advantage that there is more space in the reactor column for the moving packed bed flowing downwardly, while a smaller plate-to-plate distance between the plates allows for a better heat transfer between the plate heat exchangers and the moving packed bed flowing downward in the heating sections. A close proximity of heating plates (small passages) has the advantage that the risk of particles sticking together is further reduced. A further advantage of using thin plates with a small distance results in larger heat transfer surface, thereby further enhancing heat transfer and productivity per unit of reactor volume, while still preventing the particles from overheating and sticking. Meanwhile, the temperature of the wall can remain relatively low and quite close to that of the reacting mass, thereby prevent overheating and sticking to the wall.

Preferably, at least one of the heating sections, and preferably each of the heating sections, comprises one or more arrays of plate heat exchange elements regularly spaced from one another and distributed uniformly over a cross-section of the heating section. The advantages thereof are more uniform heating of the solid material and a more uniform flow of the moving packed bed over the cross-section of the heating section with a reduced variation in residence time in the column.

With one or more arrays is meant here that the heating section can comprise one array, or two arrays, or three arrays, or more, for which each array comprises planar heat exchange elements, regularly spaced from one another and distributed uniformly over a cross-section of the heating section. These planar heat exchange elements can be parallel and vertically positioned, or essentially so. This implies that such arrays are positioned in sequential order in the column and a moving packed bed of solid material being transported through the reactor column is transported through one such array after another. It further implies that the arrays belonging to the same heating section are not separated from each other by a gas-outlet section or an array of gas-outlet devices positioned in-between two of these heat exchanger arrays.

The gas-outlet sections in the reactor column according to invention suitably comprise one or more arrays of gas-outlet devices, more particular wherein the devices in each array are substantially evenly spread over a cross-section of the column at the gas-outlet section. Each gas-outlet section may comprise, independently from one another, one or two, or even more of such arrays.

With one or more arrays is meant here that the gas-outlet section can comprise one array, or two arrays, or eventually more than two, for which each array comprises gas-outlet devices regularly spaced from one another and distributed uniformly over a cross-section of the gas-outlet section. This implies that such arrays are positioned in sequential order in the column and a moving packed bed of solid material being transported through the reactor column will be transported passing one such an array after another. It further implies that the arrays belonging to the same gas-outlet section are not separated from each other by a heating section or an array of heat-exchangers positioned in-between two of these arrays of gas-outlet devices.

Preferably, the gas-outlet section positioned between a heating section in the corresponding multifunctional zone and a nearby heating section in the successive multifunctional zone comprises two of said arrays. The advantage of having two of such arrays, instead of one, is that capacity of the reactor column in a continuous solid-state polymerization process is increased by a large amount, or even essentially doubled, without the need of increasing the size of the reactor column, and still avoiding solid material being entrained with the water vapor being removed from the reactor column via the gas-outlet sections, or alternatively significantly reducing the risk of solid material from being entrained with the flow of gas or vapor and being removed from the reactor column via the gas-outlet sections. Furthermore, the risk of water vapor produced in one section being carried over to other sections is further reduced, thereby reducing the risk of water being carried over to upstream sections wherein the salt is still relatively cold, where it could jeopardize the granular material from being retained in the solid state, is thus further reduced.

The gas-outlet section may comprise three or more of such arrays, as this would increase the capacity in a further but small extend, far less than by going from one to two.

The gas-outlet devices may in principle be any device and have any form, shape or structure that is suitable for removing water vapor via these devices from the reactor column. Such devices suitably comprise openings for receiving gases or vapors and channels for leading the gases or vapors to an exit or to exits and removal of the gases or vapors via the exit or exits from the reactor column.

The gas-outlet sections comprising arrays of gas-outlet devices substantially evenly spread over a cross-section of the gas-outlet section favor an evenly spread out-flow of gas or vapor from a nearby heating section or two nearby heating sections and have the advantage that vapors produced in a polycondensation process in the heating sections in the reactor column are removed more uniformly, thereby preventing formation of channels in the moving packed bed in the adjacent heating section or sections and reducing the risk of solid material from being entrained with the flow of gas or vapor and being removed from the reactor column via the gas-outlet sections.

Preferably, the gas-outlet devices consist of elongated elements protruding essentially transversely with respect to the length-direction of the column into the gas-outlet sections, and wherein the elongated elements each comprise a gas-flow channel in length-direction of the elongated elements and a groove-opening or a slit-opening over the length of the elongated elements or a series of openings distributed over the length of the elongated elements.

In case the gas-outlet devices are used in combination with plate heat exchangers, they are advantageously placed perpendicular to the direction of the plates, to enhance plug flow of the solid material in the moving packed bed.

More preferably, the elongated elements have a v-shaped cross-section, a u-shaped cross-section, a semi-oblong cross-section, a semi-circular cross-section or a semi-ellipsoid cross-section, or any other cross-section, and wherein the opening or openings are facing in flow direction towards a solids discharge section. The advantages of such elongated elements with said shape is that the flow of the solid material as a moving packed bed is hampered less, while at the same time the risk of solid material from being entrained with the flow of gas or vapor and being removed from the reactor column via the gas-outlet sections is reduced.

The reactor column according to the invention can be shaped in various ways, and can be tailored, for example, to further technical requirements or in combination with specific embodiments. The space inside the reactor column is confined by the reactor wall, wherein the multifunctional zones therein are confined by sections of the reactor wall.

For example, the reactor column may have a tubular shape, or at least a main part thereof. Suitably, the multifunctional zones are confined by circular wall sections. In one embodiment, the multifunctional zones are confined by wall sections with a circular cross section. The advantage of such circular wall sections confining the multifunctional zones is that the reactor is better pressure resistant. Moreover, such circular wall sections are preferably combined with heating sections comprising vertically or essentially vertically oriented tubular heat exchangers. This has the advantage that the tubular heat exchange elements can more easily be regularly spaced from one another and distributed uniformly over a cross-section of the heating section.

In another embodiment, the multifunctional zones are confined by four wall sections comprising two essentially parallel opposite wall sections, preferably comprising two pairs of two essentially parallel opposite wall sections. This embodiment is preferably combined with essentially vertically oriented plate heat exchangers.

More preferably, the multifunctional zones are confined by four wall sections constituting an essentially rectangular cross-section. The combination of this embodiment with essentially vertically oriented plate heat exchangers has the advantage that heat exchange elements of the same size can be used and that the heat exchange elements can more easily be regularly spaced from one another and distributed uniformly over a cross-section of the heating section.

Even more preferable, the reactor column with such a rectangular cross-section is combined with a polycondensation process carried out at low pressure, for example 0.9-1.5 bara, or at a pressure in the range of −0.1 BarG and +0.5 BarG. The advantage is that the reactor column with such rectangular cross-section can be constructed relatively easily.

In a further embodiment, the reactor column is assembled from multiple column elements, comprising column elements comprising heat exchangers and column elements comprising gas-outlet devices. The advantage thereof is that the column can be easier disassembled and cleaned.

The invention also relates to a process installation for a continuous solid-state polymerization process for preparing a polyamide derived from diamine and dicarboxylic acid. The process installation comprises a reactor column according to the invention or any particular or preferred embodiment thereof as described herein above.

Herein the reactor column is suitably positioned vertically, or essentially vertically. This has the advantage that solid material is more easily moving as a moving packed bed through the reactor column while being transported by gravity.

With vertical is herein understood that the column is positioned upright at right angles (90°) to the horizon. With essentially vertical is herein understood that the column can be slightly tilted or inclined relative to the upright position. Herein the tilt angle or inclination angle is suitably at most 10°, preferably at most 5°, relative to the right angles of 90° relative to the horizon.

The invention also relates to the use of the process installation according to the invention in a polycondensation process, more particular in a continuous solid-state polymerization process for preparing a polyamide derived from diamine and dicarboxylic acid.

### DESCRIPTION OF FIGURES

FIG. 1 is a schematic representation of an embodiment of a column according to the present invention. The figure shows a column (1) comprising a charging section (2), a discharging section (3), and 5 multifuntional zones (4). Each multifuntional zone (4) comprises a heating section (5) and a gas-outlet section (6). Each heating section (5) comprises heating elements (7). Each gas-outlet section (6) comprises an array of gas outlet devices (8) with a gas outlet (9).

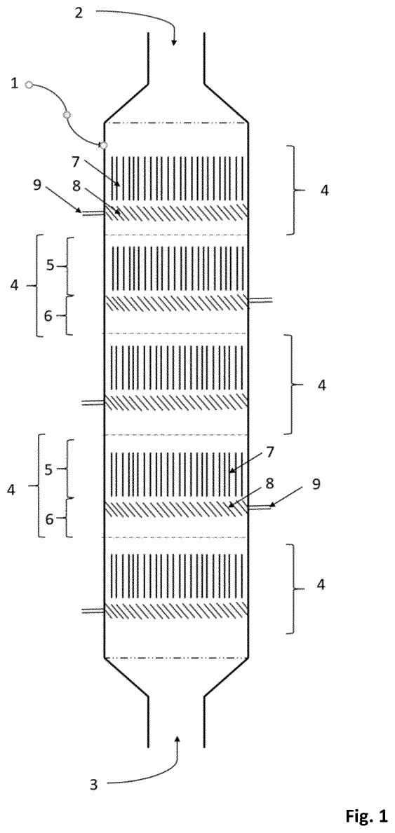

FIG. 2 is a schematic representation of another embodiment of a column according to the present invention. The figure shows a column (1) comprising a charging section (2), a discharging section (3), and 5 multifuntional zones (4). Each multifuntional zone (4) comprises a heating section (5) and a gas-outlet section (6). Each heating section (5) comprises heating elements (7). Four of the five gas-outlet sections (6) comprises two arrays of gas outlet devices (8) with a gas outlet (9). The fifth gas-outlet section (6) comprises one array of gas outlet devices (8) with a gas outlet (9). (8a) constitutes a nearby array of gas outlet devices in respect of a heating section 7a positioned upstream in respect of heating section 7a. (8b) constitutes a nearby array of gas outlet devices in respect of a heating section 7a positioned downstream in respect of heating section 7a.

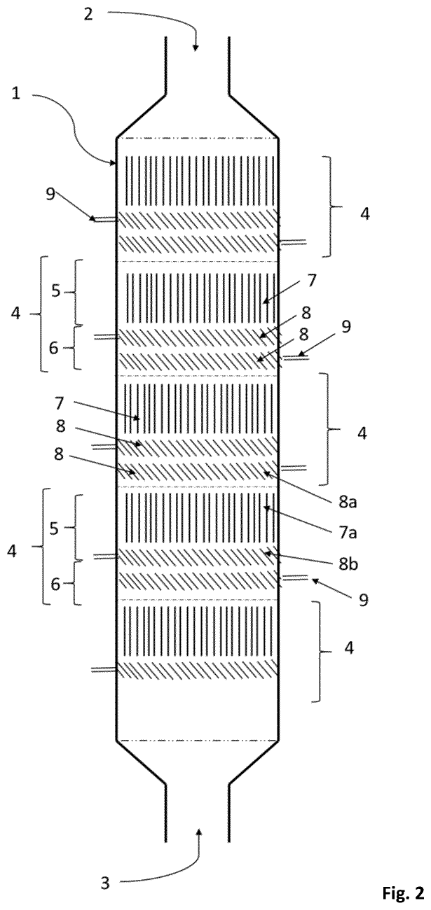

FIG. 3. Figure is a schematic representation of an array of gas-outlet devices (10) consisting of elongated elements (11) wherein the elongated elements each comprise a gas-flow channel (12) in length-direction of the elongated elements and a slit-opening (13) over the length of the elongated elements. The elongated elements can be positioned inside the reactor column such that the elongated elements are evenly spread over a cross section of the reactor column and protrude into the gas-outlet sections transversely, or essentially so, with respect to the length-direction of the column.

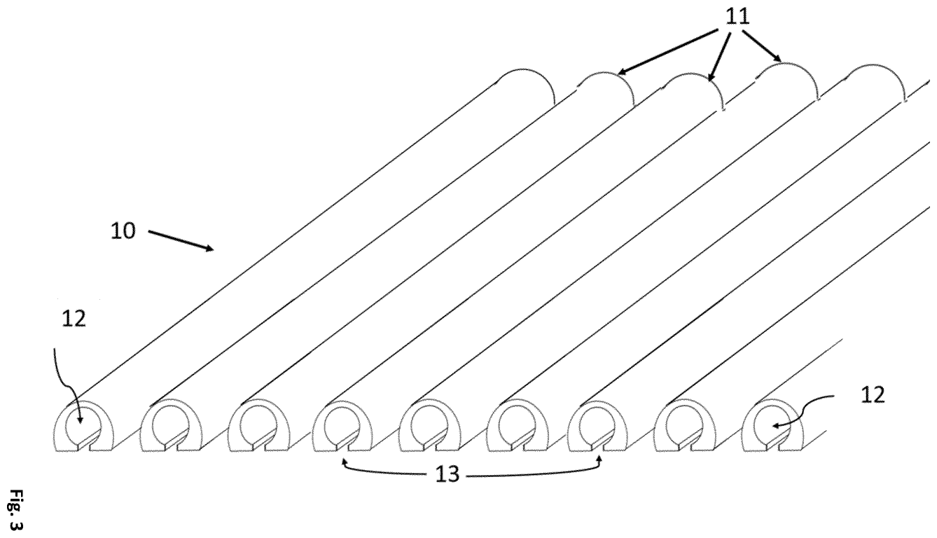

### DESCRIPTION OF AN EXAMPLE OF A PROCESS ACCORDING TO THE INVENTION

A solid-state polymerization process according to the invention is carried out in a vertically positioned reactor column according to the invention. The reactor column used for the process comprised four multifunctional zones, each comprising a heating section followed by a gas-outlet section comprising two arrays of gas outlet devices, as well as a cooling and drying sections, with an additional gas inlet and additional gas outlet in the cooling and drying sections. The column further comprised a charging section with a nitrogen inlet to ensure that no air enters into the reactor column and a discharge section is fitted with a nitrogen inlet to ensure gases formed in the column do not leave with the product.

For the process, further a salt of a mixture of butane diamine and hexane diamine and terephthalic acid in the form of a solid granular material was used.

The solid granular material was inertized with nitrogen and fed to the top of the column, together with a small purge of nitrogen gas in the top of the column, after which the solid material passed through a first heat exchanger section wherein it was heated to a temperature just below reaction temperature. Moisture released from the solids was pushed downward by the pressure of the water vapor and the nitrogen purge in the top of the column. After the first heat exchanger, the solids passed a first gas-outlet section, where nitrogen and moisture leave the column via a first array of gas outlet devices. Passing further down, the solids passed another array of gas outlet devices in the same gas-outlet section, where moisture from below flows counter-currently to the solids flow into the gas outlet devices. Progressing further downward, the solids passed the second heat exchanger. On passing through the second heat exchanger, the solids heated up further and moisture was released by the endothermic condensation reaction. About halfway through the second heat exchanger, the direction of the gas flow changed from counter-current up-flow, to co-current down flow. After the second heat exchanger, the gasses collect in another gas-outlet section, from which it could escape via a first array of gas outlet devices, followed by a second array of gas outlet devices that collected gases coming from below. On progressing further, the solids passed two further multifunctional zones comprising a heat exchanger and a gas-outlet section wherein the solids were further heated, and water vapor produced upon polycondensation was removed via the gas-outlet sections. Progressing further down, the solids passed a first cooling and drying section wherein the solids were cooled to a temperature of around 180° C. Nitrogen gas was let in via a gas inlet and removed via two gas-outlet sections, one above and one below the gas inlet, to drive off residual moisture. The drying section was followed by a cooling section, wherein the solid product was further cooled to a temperature below 60° C. The solids were discharged via the discharge section, which is fitted with a nitrogen inlet to create a small counter-current upward flow of nitrogen, to ensure that gases formed in the column do not leave with the product. During the process the throughput was adjusted to ensure sufficient conversion of the salt. The product obtained by the process was a semi-crystalline semi-aromatic polyamide in the form of a solid granular material.

1. A continuous solid-state polymerization process for preparing a polyamide derived from diamine and dicarboxylic acid, the process comprising steps of
feeding solid diammoniumdicarboxylate salt into a reactor column comprising successive multifunctional zones comprising heating sections and gas-outlet sections;
transporting the salt, or where applicable a polymerizing mixture or a polyamide resulting thereof, as a moving packed bed through the successive multifunctional zones, while
heating the salt, respectively the polymerizing mixture and polyamide, in the heating sections, thereby polycondensing the salt to form a polymerizing mixture, respectively further polycondensing the polymerizing mixture to form a polyamide, and optionally further polycondensing the polyamide to form a polyamide with higher molecular weight, and producing water vapor, and
removing the water vapor via gas-outlet sections; and
discharging the resulting polyamide from the reactor column;
wherein the salt, the polymerizing mixture and polyamide are kept in the solid-state and wherein the heating sections comprise static heat exchangers.

2. The process according to claim 1, wherein the solid diammoniumdicarboxylate salt is fed into the reactor column via a charging section and the resulting polyamide is discharged from the reactor column via a discharge section, and wherein a purge of inert gas is fed into the charging section, or into the discharge section, or into both.

3. The process according to claim 1, wherein the process is carried out at a gas pressure in the range of −0.1 to +0.5 BarG.

4. The process according to claim 1, wherein the static heat exchangers are heated to a temperature T_{HE} being at least 15° C. below, below the lowest of the melting temperature of the salt (Tm-salt), the melting temperature of the reaction mixture (Tm-mixture), and the melting temperature of the polyamide (Tm-polyamide), wherein the melting temperature (Tm) is measured by the DSC method according to ISO-11357-3.2, 2009, in a nitrogen atmosphere with a heating rate of 20° C./min, in the first heating cycle.

5. The process according to claim 1, wherein the sections in the column are confined by wall sections of the column, and wherein wall sections of the heating sections are heated to a temperature TWS in the range from {T_{HE}−10° C.} to and including {T_{HE}+10° C.}, wherein T_{HE} is the temperature of the static heat exchangers in the corresponding heating section.

6. The process according to claim 1, wherein the reactor column comprises at least 3 successive multifunctional zones comprising heating sections and gas-outlet sections, preferably at least 4 of these multifunctional zones.

7. The process according to claim 1, wherein the process comprises a cooling step, prior to the discharging step, comprising transporting the polyamide to and through a cooling section comprising static heat exchangers, while cooling the polyamide in the cooling section, and transporting the cooled polyamide to a discharge section.

8. The process according to claim 1, wherein the solid diammoniumdicarboxylate salt fed into a reactor column is a particulate material having a particle size distribution with a median particle size (d50) in the range of 0.05-5 mm, preferably 0.1-3 mm, more preferably 0.2-1 mm.

9. The process according to claim 1, wherein the solid diammoniumdicarboxylate salt comprises an aliphatic diamine and an aromatic dicarboxylic acid, and wherein the polyamide prepared by the process is a semi-crystalline semi-aromatic polyamide having a melting temperature, measured by the DSC method according to ISO-11357-3.2, 2009, in a nitrogen atmosphere with heating and cooling rate of 20° C./min, of at least 280° C.

10. Process according to claim 1, wherein the polyamide discharged from the reactor column has a viscosity number of at least 20 ml/g, preferably at least 50 ml/g, measured in 96% sulphuric acid (0.005 g/ml) at 25° C. by the method according to ISO 307, fourth edition; or wherein the polyamide has a conversion of carboxylic acid groups into amide groups of at least 90%, preferably at least 95%, more preferably at least 98%, relative to the carboxylic acid groups in the solid diammoniumdicarboxylate salt.

11. A reactor column for a continuous solid-state polycondensation process, the reactor column comprising at least three successive multifunctional zones, each of the multifunctional zones comprising a heating section comprising static heat exchangers and a gas-outlet section comprising gas-outlet devices.

12. The reactor column claim 11, wherein the static heat exchangers are selected from vertically or essentially vertically oriented tubular heat exchangers and vertically or essentially vertically oriented plate heat exchangers.

13. The reactor column according to claim 12, wherein the tubular heat exchangers have an inner diameter in the range of 0.5-5 cm and a core-to-core distance in the range of 1-8 cm.

14. The reactor column according to claim 12, wherein the plate heat exchangers have
a thickness in the range of 0.25-3 cm, preferably 0.5-2 cm; and/or
a core-to-core distance in the range of 1-12 cm, preferably 2-8 cm; and/or
a plate-to-plate distance between the plates in the range of 0.5 mm-8 cm, preferably 1-6 cm, more preferably 2-5 cm.

15. The column according to claim 11, wherein the heating sections comprise one or more arrays of plate heat exchange elements regularly spaced from one another and distributed uniformly over a cross-section of the heating section.

16. The reactor column according to claim 11, wherein gas-outlet sections positioned between two heating sections comprise two arrays of gas-outlet devices substantially evenly spread over a cross-section of the gas-outlet section.

17. The reactor column according to claim 16, wherein the gas-outlet devices consist of elongated elements protruding essentially transversely with respect to the length-direction of the column into the gas-outlet sections, and wherein the elongated elements each comprise a gas-flow channel in length-direction of the elongated elements and a groove-opening or a slit-opening over the length of the elongated elements or a series of openings distributed over the length of the elongated elements.

18. The column according to claim 11, wherein circular wall sections confine the multifunctional zones, or wherein the multifunctional zones are confined by four wall sections comprising two essentially parallel opposite wall sections, preferably comprising two pairs of two essentially parallel opposite wall sections, more preferably confined by four wall sections constituting an essentially rectangular cross-section.

19. Process installation comprising a reactor column according to claim 11.

20. Use of the process installation according to claim 19, or the reactor column in a polycondensation process, more particular in a continuous solid-state polymerization process for preparing a polyamide derived from diamine and dicarboxylic acid.
